(19) United States
(12) Patent Application Publication
(10) Pub. No.: US 2018/0193972 A1
(43) Pub. Date: Jul. 12, 2018

(54) Battery-Operated Portable Power Tool Having a Motor Axis and a Working Axis

(71) Applicant: Robert Bosch GmbH, Stuttgart (DE)

(72) Inventors: Joachim Schadow, Stuttgart (DE); Florian Esenwein, Leinfelden-Echterdingen (DE); Achim Trick, Sielmingen (DE); Manfred Lutz, Filderstadt (DE)

(21) Appl. No.: 15/740,294

(22) PCT Filed: May 2, 2016
(86) PCT No.: PCT/EP2016/059770

§ 371 Date: Dec. 27, 2017

(30) Foreign Application Priority Data
Jun. 29, 2015 (DE) 10 2015 212 042.2

(51) Int. Cl. B24B 23/02; B24B 47/12; B25F 5/00

(52) U.S. Cl. CPC B24B 23/028; B25F 5/001; B24B 47/12

(57) ABSTRACT

A battery-operated grinder, in particular an angle grinder, includes an electronically commutated electric motor and a working shaft. The electric motor is configured to act on a motor shaft. The motor shaft and the electric motor define a motor axis which is coaxial with the motor shaft. The working shaft carries a machining tool and defines a working axis which is coaxial with the working shaft. The motor axis and the working axis are arranged in a parallel manner, spaced apart from one another, and are connected together via a belt drive.

The invention relates to a portable power tool having a motor axis and a working axis.

### PRIOR ART

A portable power tool according to the preamble of claim 1 is already known from the prior art.

### DISCLOSURE OF THE INVENTION

The battery-operated grinding appliance according to the invention according to the preamble of claim 1 is realized, in particular, in the form of an angle grinder. An electronically commutated electric motor drives a motor shaft, wherein the motor shaft, with the electronically commutated electric motor, defines a motor axis. The motor axis in this case is a theoretical axis, which is coaxial with the motor shaft. A working shaft carries a machining tool, wherein the working shaft defines a working axis. The working axis in this case is a theoretical axis, which is coaxial with the working shaft. It is proposed that the motor axis and the working axis are disposed, in particular, in a parallel manner, spaced apart from one another, and are connected to each other via a belt drive. “In a parallel manner” is to be understood here to mean, in particular, that the motor axis and the working axis are at an angle in relation to each other that is between 0 and 5°. Use of a belt drive makes it possible, advantageously, to achieve a low rotational speed of the machining tool with a high rotational speed of the electronically commutated electric motor, with the result that the machining tool can have, for example, a greater diameter.

Moreover, the battery-operated grinding appliance according to the invention can be realized in a very compact manner.

Advantageously, the machining tool is a grinding, parting or roughing disk that has a diameter d_{disk}. Advantageously, the rotational speed n_{disk} of the machining tool may be between 7500 rpm and 15500 rpm, especially between 10000 rpm and 13500 rpm, and particularly preferably may be 11000 rpm, wherein a motor rotational speed is from 15000 to 30000, in particular from 17500 to 22000 rpm, but in particular is less than 13000 rpm. As a result, particularly advantageously, the diameter d_{disk} of the machining tool may be 100 to 150 mm, but preferably 115 to 125 mm. The specifications for the diameter d_{disk} of the machining tool do not take account of any possible production tolerances. This is achieved, advantageously, in that the belt drive has a reduction ratio of 1.5 to 3.5, especially of between 1.8 and 2.5, but preferably of 2.1. Thus, advantageously, the battery-operated grinding appliance according to the invention can be realized in a very compact manner.

Advantageously, the electronically commutated electric motor is an internal-rotor motor. As a result, high rotational speeds can be achieved, with a high power density. It is also conceivable, however, for the electronically commutated electric motor to be realized as an external-rotor motor.

In the preferred embodiment according to the invention, the battery-operated grinding appliance has a rechargeable battery, which serves as an energy source for the battery-operated grinding appliance. Advantageously, the rechargeable battery has a battery voltage that is between 3.6 and 40 V, in particular between 4.0 and 36 V, especially between 7.2 and 20 V, particularly preferably between 8.0 and 18 V, but preferably 10.8 V, but particularly preferably 12 V.

In a further embodiment according to the invention, the battery-operated grinding appliance has an actuator element, wherein the actuator element acts on the belt drive via a push rod.

Advantageously, the battery-operated grinding appliance is of a weight of between 400 and 750 g, in particular between 450 and 650 g, preferably between 500 and 550 g. This weight excludes the weight of the rechargeable battery. The rechargeable battery is of a weight of between 150 and 400 g.

Further advantages and expedient embodiments are given by the description of the figures and the drawings.

### DRAWINGS

Exemplary embodiments of a portable power tool according to the invention are shown in the drawings.

There are shown:

FIG. 1 a first embodiment of a battery-operated grinding appliance, in a schematic representation,

FIG. 2 a second embodiment of a battery-operated grinding appliance, in a schematic representation,

FIG. 3 a third embodiment of a battery-operated grinding appliance, in a schematic representation,

FIG. 4 a partial view of a belt drive, in a schematic representation.

### DESCRIPTION

Component parts that are the same in the differing exemplary embodiments are denoted by the same references.

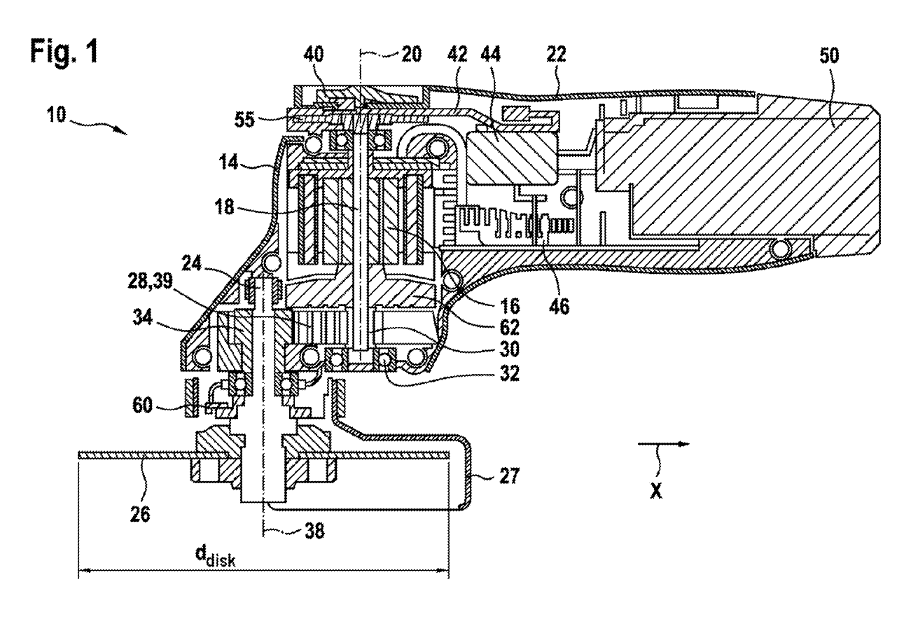

FIG. 1 shows a battery-operated grinding appliance 10 in the form of an angle grinder. An angle grinder is an electrically driven, portable power tool having a rotating round grinding disk. The grinding disk is driven via a right-angle gear transmission, which gives the angle grinder its name.

In the form of an angle grinder means, in this case, that the battery-operated grinding appliance 10 is an electrically driven, portable power tool having a rotating round grinding disk, but does not have a right-angle gear transmission. Moreover, the external design of one angle grinder is similar.

Disposed in a first housing part 14 there is an electronically commutated electric motor 16, which drives a motor shaft 18. The motor shaft 18, together with the electronically commutated electric motor 16, forms a motor axis 20. The motor axis 20 is a theoretical axis, which is coaxial with the motor shaft 18. A second housing part 22 is connected to the first housing part 14. The second housing part 22 is realized as a handle. A working shaft 24 is disposed in the first housing part 14, and carries a machining tool 26. In the exemplary embodiment, the machining tool 26 is a grinding, parting or roughing disk. A protective hood 27 covers the machining tool 26, at least partly. As can be seen in FIG. 1, the electronically commutated electric motor 16 is connected to the working shaft 24 via a belt drive 28. When the electronically commutated electric motor 16 starts to rotate, it transmits a torque, or a rotational motion, to the motor shaft 18. Disposed on the motor shaft 18 are a first toothed sleeve 30 and a first bearing 32. Seated on the working shaft 24, adjacently to the first toothed sleeve 30, there is a second toothed sleeve 34 and a second bearing 36. A belt 39, which transmits the torque from the motor shaft 18 to the working shaft 24, is tensioned over the first toothed sleeve 30 and the second toothed sleeve 34.

The working shaft 24 defines a working axis 38, which is coaxial with the working shaft 24. The advantage of the design according to the invention consists in that the motor axis 20 and the working axis 38 are disposed in a parallel manner in relation to each other. “In a parallel manner” is to be understood here to mean that the two axes (20, 38) are disposed at an angle in relation to each other that is between 0 and 5°.

As can be seen in FIG. 1, the grinding, parting or roughing disk 26 has a diameter d_{disk}.

As a result of the transmission of the rotational speed of the electronically commutated electric motor 16 to the working shaft 24 by the belt drive, in the embodiment according to the invention the rotational speed n_{disk} of the machining tool 24 is advantageously between 7500 rpm and 15500 rpm, especially between 10000 rpm and 13500 rpm, and preferably 11000 rpm, with a motor rotational speed of from 15000 rpm to 30000 rpm, but especially between 17500 and 22000 rpm. As a result, advantageously, the diameter d_{disk} of the machining tool 24 can be between 100 and 150 mm, but preferably between 115 and 125 mm. The specifications for the diameter d_{disk} of the machining tool do not take account of any possible production tolerances.

In the embodiment according to the invention, the belt drive 28 has a reduction ratio of from 1.5 to 3.5, especially from 1.8 to 2.5, but preferably of 2.1. In particular, however, the reduction ratio of the belt drive 28 is is adaptable.

In the exemplary embodiment, the electronically commutated electric motor 16 is realized as an internal rotor. In motors of this type, on the motor housing there is a stator, which carries the current-carrying windings. A rotor, which carries the permanent magnets, is connected to the motor shaft 18. The advantages of the internal-rotor motor are a high achievable rotational speed together with a high power density. It is also conceivable, however, for the electronically commutated electric motor 16 to be realized as an external-rotor motor.

Disposed on the first housing 14 there is a switching element 40. The switching element 40 is provided for switching on the battery-operated grinding appliance 10. In the exemplary embodiment, the switching element 40 is realized as a switch button. Upon actuation of the switch button 40, an internal switch 44, which switches on an electronic system 46, is actuated via an internal switching slide 42. The electronic system 46 energizes and/or controls, by closed-loop and/or open-loop control, the electronically commutated electric motor 16.

A rechargeable battery 50 is disposed on the second housing part 22. The rechargeable battery 50 serves to supply energy for the battery-operated grinding appliance 10.

As can be seen in FIG. 1, the rechargeable battery 50 is disposed on a side that faces away from the machining tool 26. The direction of insertion of the rechargeable battery 50 in this case is in a direction of main extent x of the battery-operated grinding appliance 10.

The battery voltage is in a range of between 3.6 and 40 V, in particular between 4.0 and 36 V, especially between 7.2 and 20 V, particularly preferably between 8.0 and 18 V. Preferably, the battery voltage is 10.8 V, but particularly preferably 12 V. The values of the battery voltage do not take account of any possible battery voltage fluctuations.

The rechargeable battery 50 is composed, in particular, of lithium-ion battery cells. The rechargeable battery 50 in this case comprises one or more rows of battery cells, which in turn are connected in parallel and/or in series to each other. Each individual cell is of a length of approximately 65 mm, and of a diameter of approximately 18 mm. It is also conceivable, however, for a cell to be of a length of from 65 to 70 mm, and of a diameter of from 14 to approximately 20 mm. These specifications do not take account of any possible production tolerances.

Lithium-ion rechargeable batteries are characterized by a high energy density and thermal stability, even at high loads, which means a high power output. A further major advantage is the low self-discharge, which has the effect that the rechargeable batteries are also ready for use even in the case of long periods of non-use. Ensuing from these advantages are the advantages of the application according to the invention, in particular that, on the one hand, the battery-operated grinding appliance 10 can be small and compact in its dimensions and, on the other hand, provide high power outputs.

It is also conceivable, however, for the rechargeable battery 50 to be composed of lithium-air cells, of lithium-sulfur cells, lithium-polymer cells or the like. Furthermore, the rechargeable battery 50 may be realized in a geometric embodiment other than that shown, such as, for example, in an angular embodiment.

In the exemplary embodiment in FIG. 1, the rechargeable battery 50 is realized as an exchangeable, rechargeable battery 50. It is also conceivable, however, for the rechargeable battery 50 to be realized as an integrated unit.

Furthermore, it is possible, by actuation of a switching element 40, to activate a blocking device in order to lock the working shaft 24. The spindle locking may be effected in a form-fitting and/or force-fitting manner. In this case, there is a latching disk 55 attached to the working shaft 24. The spindle locking may be effected automatically. It is also conceivable, however, for the spindle locking to be manually actuated.

A sensor unit 60 is realized, in particular, as a Hall sensor. The sensor unit 60 determines the position of the rotor relative to the stator of the electronically commutated electric motor 16.

In the exemplary embodiment in FIG. 1, a fan 62 is attached to the motor shaft 18 and disposed between the electronically commutated electric motor 16 and the belt drive. It is also conceivable, however, that the fan 62 is not attached to the motor shaft 18, but is connected to the motor shaft 18 via elements such as belts or toothed wheels. It is equally conceivable that other cooling systems, such as Peltier elements, heat sinks, additional actuators having air-ducting elements or the like are used.

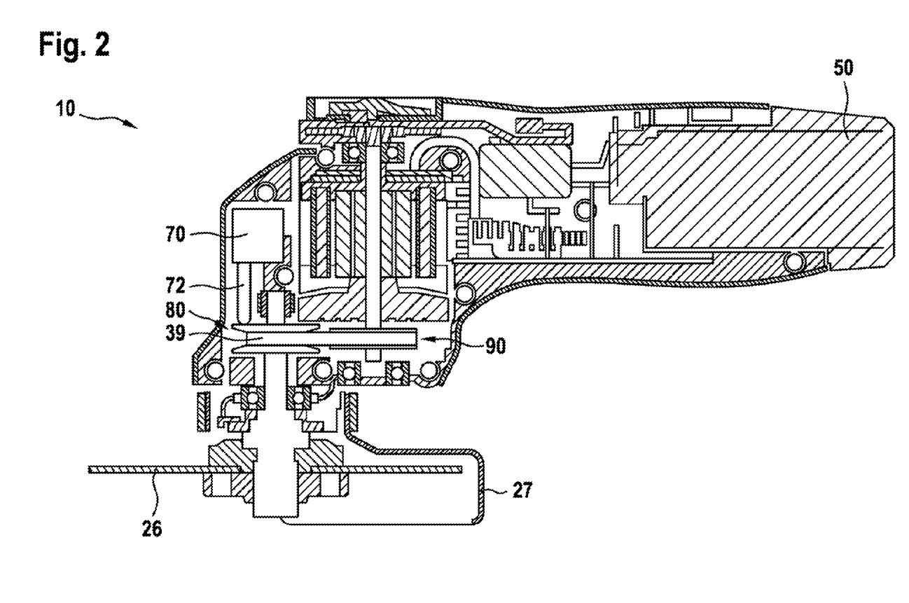

FIG. 2 shows a second embodiment of the battery-operated grinding appliance 10. In this embodiment according to the invention, an actuator element 70 acts on the belt drive 28 via a push rod 72. It is also conceivable, however, for a mechanical positioning element, for example a positioning wheel, to be used.

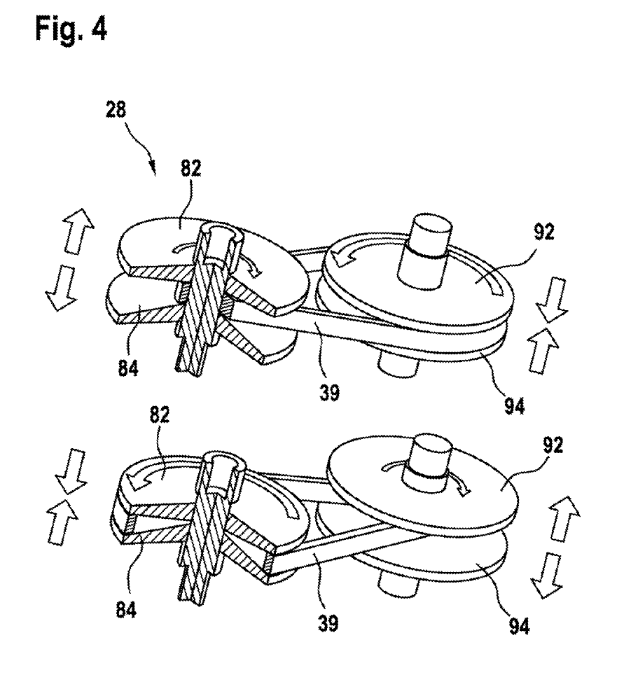

When, as can be seen in FIG. 4, the actuator 70 moves the push rod 72 in the direction of the first pulley pair 80, the first pulley 82 of the first pulley pair 80 is forced in the direction of the second pulley 84 of the first pulley pair 80, as a result of which the distance between the first pulley 82 of the first pulley pair 80 and the second pulley 84 of the first pulley pair 80 is reduced. The belt 39 is thereby forced outward. Since the length of the belt 39 is constant, a second pulley pair 90 adapts.

The first pulley 92 of the second pulley pair 90 is axially displaceable, against a spring force, relative to a second pulley 94 of the second pulley pair 90. If the effective diameter on the first pulley pair 80 is increased, the tension on the belt 39 is increased, and the two pulleys 92, 94 of the second pulley pair 90 are forced apart against their spring force. The spring force is designed such that the belt 39 does not slip at the anticipated torques. Furthermore, it is conceivable that a mechanical coupling or a further actuator is provided for adaptation of the second pulley pair 90. The belt 39 may be realized as a toothed belt, as a flat belt, as a V-belt, as a band belt, as cord belt, as a chain or the like.

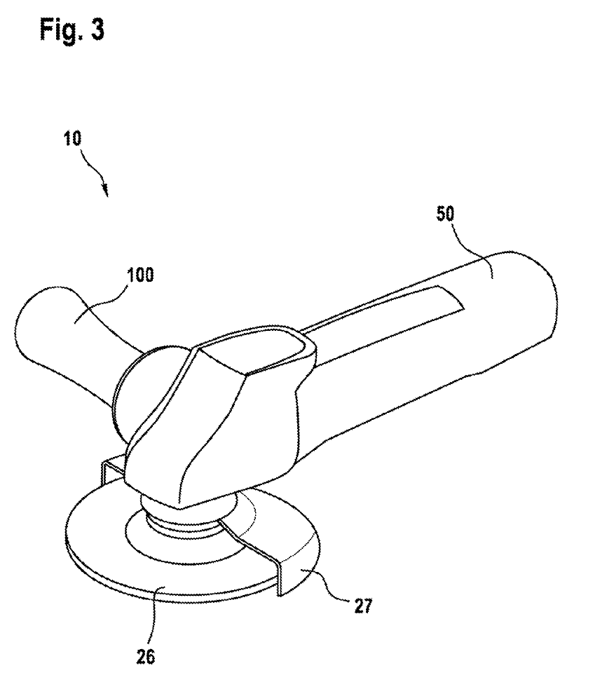

FIG. 3 shows an embodiment of the battery-operated grinding appliance 10 having an ancillary handle 100. An operator can thus advantageously operate the battery-operated grinding appliance 10 with both hands. The ancillary handle 100 can be mounted in such a manner that the battery-operated grinding appliance 10 can be operated both by left-handers and by right-handers.

The battery-operated grinding appliance 10 is of a weight of between 400 and 750 g, in particular between 450 and 650 g, preferably between 500 and 550 g. This weight excludes the weight of the rechargeable battery 50. The rechargeable battery 50 is of a weight of between 150 and 400 g.

1. A battery-operated grinding appliance, comprising:
an electronically commutated electric motor configured to act on a motor shaft, the motor shaft and the electric motor defining a motor axis, the motor axis coaxial with the motor shaft;
a working shaft configured to carry a machining tool, the working shaft defining a working axis, the working axis coaxial with the working shaft; and
a belt drive configured to connect the motor shaft and the working shaft,
wherein the motor axis and the working axis are parallel and spaced apart from one another.

2. The battery-operated grinding appliance as claimed in claim 1, wherein:
the machining tool is a grinding, parting, and/or roughing disk, and
the machining tool has a diameter.

3. The battery-operated grinding appliance as claimed in claim 2, wherein:
a rotational speed of the machining tool is between 7500 rpm and 15500 rpm;
a motor rotational speed of the electric motor is 15000 to 30000 rpm; and
the diameter of the machining tool is 100 to 150 mm.

4. The battery-operated grinding appliance as claimed in claim 1, wherein the belt drive has a reduction ratio of 1.5 to 3.5.

5. The battery-operated grinding appliance as claimed in claim 4, wherein the reduction ratio of the belt drive is adaptable.

6. The battery-operated grinding appliance as claimed in claim 1, wherein the electric motor is an internal-rotor motor.

7. The battery-operated grinding appliance as claimed in claim 1, further comprising:
a rechargeable battery configured to serve as an energy source and having a battery voltage of 3.6 V to 40 V.

8. The battery-operated grinding appliance as claimed in claim 1, further comprising:
an actuator element configured to act on the belt drive via a push rod.

9. The battery-operated grinding appliance as claimed in claim 7, wherein:
a weight of the battery-operated grinding appliance is between 400 g and 750 g; and
the weight of the battery-operated grinding appliance excludes a weight of the rechargeable battery.

10. The battery-operated grinding appliance as claimed in claim 1, wherein the battery-operated grinding appliance is an angle grinder.

11. The battery-operated grinding appliance as claimed in claim 3, wherein:
the rotational speed of the machining tool is between 10000 rpm and 13500 rpm; and
the diameter of the machining tool is 115 mm to 125 mm.

12. The battery-operated grinding appliance as claimed in claim 4, wherein the reduction ratio is between 1.8 and 2.5.

13. The battery-operated grinding appliance as claimed in claim 7, wherein the battery voltage is 12 V.

14. The battery-operated grinding appliance as claimed in claim 9, wherein the weight of the battery-operated grinding appliance is between 500 g and 550 g.
